(19) United States
(12) Patent Application Publication
(10) Pub. No.: US 2026/0235431 A1
(43) Pub. Date: Aug. 13, 2026

(54) FILL VOLUME DETERMINATION FOR TILTABLE CONTAINERS

(71) Applicant: Endress+Hauser SE+Co. KG, Maulburg (DE)

(72) Inventors: Johannes Baureithel, Wehr (DE); Alexander Vogel, Kirchzarten (DE); Alexey Malinovskiy, Maulburg (DE); Markus Vogel, Schopfheim (DE)

(21) Appl. No.: 19/155,376

(22) PCT Filed: Jan. 26, 2024
(86) PCT No.: PCT/EP2024/051889

§ 371 Date: Aug. 11, 2025

(30) Foreign Application Priority Data
Feb. 10, 2023 (DE) 10 2023 103 242.9

(51) Int. Cl. G01F 23/22; G01F 23/80

(52) U.S. Cl. CPC G01F 23/22; G01F 23/80

(57) ABSTRACT

A method for creating a linearization model, which describes a relationship between a fill level value measured pointwise by means of a travel time method and a fill volume of a fill substance in a tiltable container, using a corresponding measuring system having a travel time-based, fill level measuring device and a superordinated evaluation unit, can determine the fill volume in the container with little effort. The container inner geometry is taken into consideration in the linearization model and a fill substance type-specific, bulk-good angle and a state change of the container. In such case, the type of state change distinguishes between the tilting, the emptying, and filling of the container.

The invention relates to determining fill volume, especially in tiltable containers.

In process automation technology, field devices are applied for registering process parameters. Suitable measuring principles are implemented in the field device for registering particular process parameters of interest. Examples of process parameters include fill level, flow, pressure, temperature, pH value, redox potential, media-density and conductivity. The most varied of field device types are manufactured and sold by the Endress+Hauser group of firms.

Travel time-based measuring methods are commonly used for fill level measurement of fill substances in containers. Applied for signal travel time measurement can be, on the one hand, probe based measuring methods, using, for example, the TDR measuring principle (“Time Domain Reflectometry”). On the other hand, also ultrasonic, or radar based, measuring methods are used, which operate, for example, based on the pulse travel time principle or the FMCW principle (“Frequency Modulated Continuous Wave”) and apply corresponding high frequency signals radiated via suitable antennas. The FMCW based fill level measuring method is described, for example, in publication DE 102013108490 A1.

Starting from the measured fill level, often of interest is to determine the fill volume occupied by the fill substance currently in the container. This is possible, when a linearization model, also known as a linearizing table, tank table or linearization curve, is present for the container. This represents the relationship between the fill level value and the corresponding fill volume, which the fill substance currently occupies in the container. In such case, the linearization model is independent of the type of fill substance in the container and can be present in the form of an analytical function or a table. The creation of a linearization model is described, for example, in the publication WO 2020/216462.

The direct converting of the fill level value by means of the linearization model is based, however, on the boundary condition, or assumption, that the fill substance surface is flat, or that the fill substance is low viscosity. When the fill level measuring device, or the measuring system, in which the fill level measuring device is integrated, knows the density of the fill substance type, then, moreover, the mass of the fill substance can be ascertained based on of the measured fill level, the linearization model and the density.

In the case of liquid, or low viscosity, fill substances, whose fill substance surface is flat, a pointwise fill level measurement is sufficient for determining the fill level, and the fill volume. In these cases, the fill level measuring device is so oriented on the container that the probe, or the antenna, is directed approximately perpendicularly downwards toward the fill substance, to determine the fill level, or the distance from the fill substance surface. In the case of high viscosity or solid-type fill substances, such as cement, gravel or grain, the fill level, or the fill substance surface, can, however, be nonuniform, for example, because of bulk good cones, such that the fill level value ascertained by the fill level measuring device is only conditionally informative. The same problem results in the case of tiltable containers, for example, after the raising of mobile cement-silos. In such case, the fill substance surface extends during, or directly after, the raising inclined downwards in the tilt direction. Moreover, especially in the case of such measurement applications, primarily the current fill volume, or the mass, of the contained fill substance, and not its fill level, is of interest.

A way of determining fill volume in the case of non-flat fill level upper surfaces is the three dimensional registering of the fill substance surface, for example, by means of a laser scanner or an imaging radar. A radar-based, fill level measuring device, which determines the fill level three dimensionally is described, for example, in publication DE 102018112819 A1. Camera-supported registering of the fill substance surface is described, for example, in the patent publication DE 102018211144 B4, as well as in the patent EP 3746752 B1. The application of such field device types is, however, associated with corresponding capital- and operating costs.

It is, accordingly, an object of the invention to be able to determine the fill volume in tiltable containers with economically justifiable method and means.

The invention achieves the object by a method for creating a linearization model, which describes a relationship between a fill level value, which is measured pointwise by means of a travel time method, and the fill volume of a fill substance in a container. In such case, the method includes method steps as follows:
determining a container inner geometry,
determining at least one geometric bulk-good variable, for example, a characteristic bulk-good angle, and
creating the linearization model as a function of:
   the inner geometry of the container,
   the geometric bulk-good variable, and
   a preceding, or expected, type of state change of the container.

In such case, the linearization model can be created, for example, as a numerical table or as a mathematical function.

The invention is based, thus, on the one hand, on empirical evidence that each fill substance-type forms a unique bulk-good angle, thus a geometric variable, which depends exclusively on the fill substance properties, thus mainly the density, moisture, porosity, grain size, roughness, and/or viscosity. On the other hand, the invention utilizes the insight that the bulk-good angle reestablishes itself in the case of reproducible changes, such as, for example,
(i) the erecting of the container after its filling,
(ii) the filling of the container after its erecting or emptying,
(iii) the emptying of the container after its erecting.

In the first case, the bulk-good angle at least approximately defines the angle of the falling fill substance surface. In the second and third cases, the characteristic bulk-good angle forms the cone angle of the bulk-good cone, or the extraction funnel. On this basis, different geometric bodies can be case-dependently defined and used in the relevant linearization model, in order to match the value of the fill volume correspondingly.

The bulk-good variable, thus for instance the bulk-good angle, must be known for the relevant fill substance-type and can be ascertained, for example, by model based calculation as a function of at least one of the above mentioned fill substance properties. Likewise possible, however, is an experimental determination, for example, by filling the container with a known fill-volume and then standing the container up. By measuring fill level value in the case of this type of state change, taking into consideration the container inner geometry and the known fill-volume of the fill substance, the bulk-good angle can be ascertained.

A corresponding measuring system for determining the fill volume comprises components as follows:
a fill level measuring device arrangeable on the container for pointwise measuring of fill level of the fill substance, and
an evaluation unit, in which is implemented a linearization model as above described and which is designed:
   to ascertain a preceding, or expected, type of state change, and
   to calculate fill volume based on measured fill level and based on the linearization model for the ascertained type of state change.

When the density of the fill substance-type is furnished in the evaluation unit, the evaluation unit can in the case of corresponding design determine the mass of the fill substance located in the container based on the density as well as based on the ascertained fill volume.

How and where the evaluation unit is implemented is not fixedly prescribed within the scope of the invention. In the simplest case, the evaluation unit can be implemented in the form of an independent and, in given cases, portable microcontroller, which is arranged directly on the container or near to it. Moreover, the evaluation unit can be a hardware component of the fill level measuring device. In contrast, however, also a central or decentral server can function as evaluation unit. Within the scope of the invention, the terminology, “unit”, means, in principle, any electronic circuit, or hardware, which is suitably designed for the intended application. It can, thus, depending on requirements, be an analog circuit for producing, and/or processing, corresponding analog signals. It can also be a digital circuit, such as an FPGA, or a storage medium in cooperation with a program. In such case, the program is designed to perform the appropriate method steps, or to apply the needed computer operations of the unit. In this context, an electronic unit can be formed from a plurality of interconnected memory/computing units. In order to ascertain the currently relevant type of state change, the measuring system can preferably have a position, or acceleration, sensor. In such case, the sensor can preferably be designed as an integral component of the fill level measuring device, when the fill level measuring device is secured on the tiltable container.

In the context of the invention, it is also not fixedly prescribed, whether the method of the invention for creating the linearization model unit is performed externally and the linearization model then transmitted to the measuring system. Another option is that the evaluation unit of the measuring system of the invention appropriately creates the linearization model. Independently of whether the linearization model is created by the evaluation unit or externally, the bulk-good angle can in the case of corresponding design be entered manually into the unit. It does not matter whether the value originates from a calculation, is an experimental value, or is simply an estimate. The final method for determining the fill volume in the container by means of the measuring system proceeds with method steps as follows:
pointwise measuring of fill level, and
calculating fill volume, or mass, based on the measured fill level value and the linearization model.

The invention will now be explained in greater detail based on the appended drawing, the figures of which show as follows:

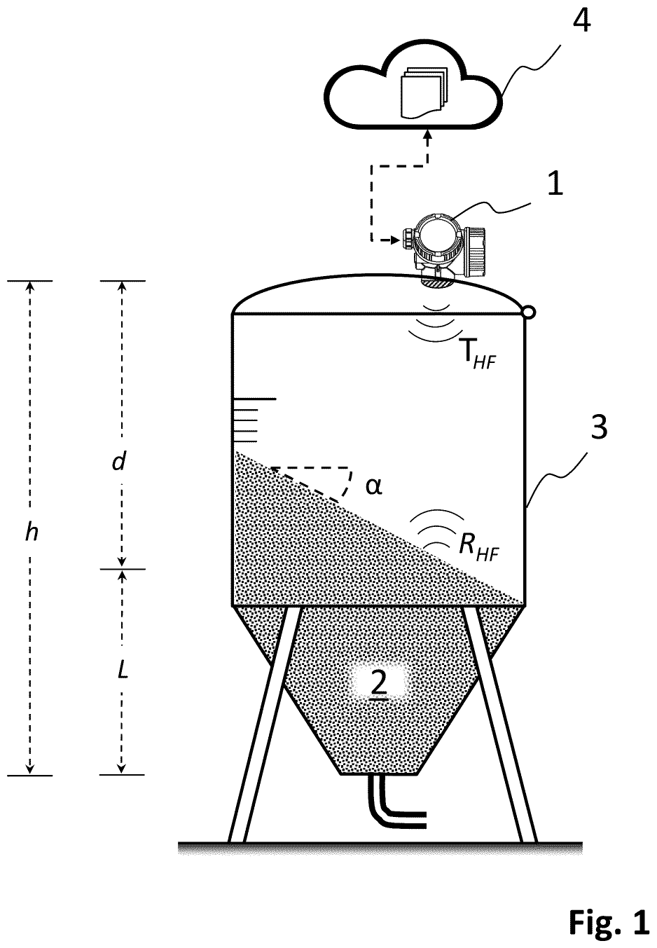

FIG. 1 a measuring system of the invention for determining fill-volume of a tiltable container; and

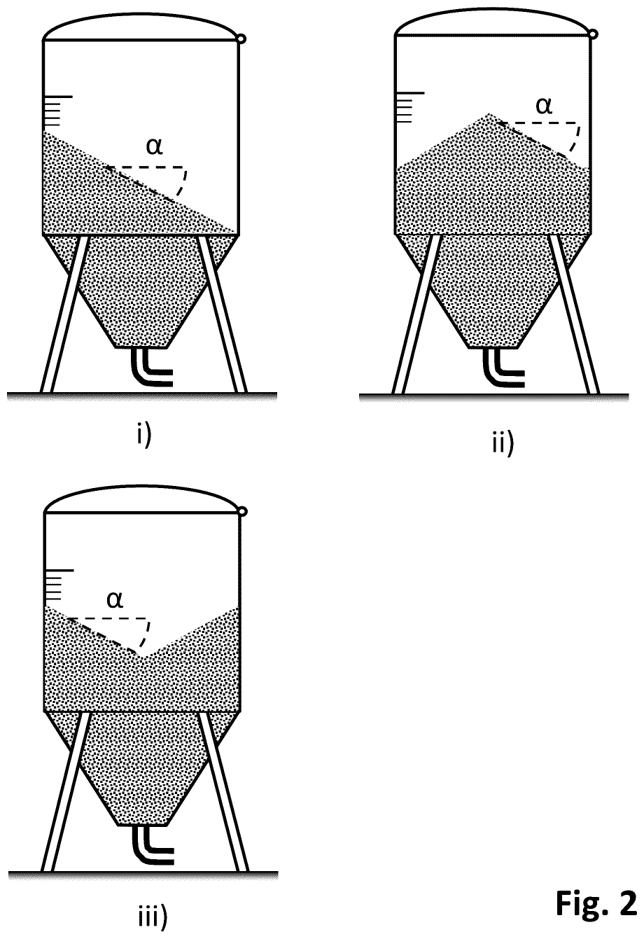

FIG. 2 different types of state change in the container with reference to tilting, filling and emptying.

For an understanding of the invention, FIG. 1 shows a tiltable container 3, such as, for example, a raisable cement-silo, wherein a corresponding fill substance 2 is located in the container 3. In the context of the invention, the terms “tiltable”, “raisable” and “erectable” include not only angle changes of 90°, but, for example, also containers 3 tiltable/erectable by only 45°. In order, for example, to control a filling or emptying procedure, the fill volume, which the fill substance 2 instantaneously occupies in the container 3, must be registered. For this in the embodiment shown in FIG. 1, a freely radiating, radar fill level measuring device 1 is mounted on the container 3 in such a manner that the fill level measuring device 1 in the erected state of the container 3 is located at a known, installed height h above the container-floor 2. In such case, the fill level measuring device 1 is arranged, horizontally considered, about halfway between the container wall and the container middle. Moreover, the fill level measuring device 1 is so oriented that transmitted radar signals T_{HF} of the implemented radar principle are transmitted approximately vertically downwards in the direction of the fill substance 2.

After reflection of the radar signal T_{HF} on the fill substance surface, the fill level measuring device 1 receives the radar signals R_{HF} reflected on the fill substance surface after a defined signal travel time, wherein the signal travel time depends on the distance d of the fill level measuring device 1 from the reflection point on the fill substance surface. Since the fill level measuring device 1 can measure the signal travel time based on the reflected radar signal R_{HF} and from that determine the corresponding distance d, it is then possible for the fill level measuring device 1 to ascertain the fill level value L at a point of the fill substance surface based on the formula

$$d = h - L .$$

In such case, the installed height h of the fill level measuring device 1 above the container-floor must be furnished in the fill level measuring device 1. In contrast with the embodiment shown in FIG. 1, it is also possible within the scope of the invention to apply, instead of a radar-based measuring method, an ultrasonic-based fill level measuring device, or a probe-based fill level measuring device based on TDR (“Time Domain Reflectometry”).

As a rule, the fill level measuring device 1 is connected via a suitable interface, for instance, “PROFIBUS”, “HART”, “WirelessHART”, “4-20 mA”, “Bluetooth”, or “Ethernet”, to a superordinated unit 4, such as, e.g., a process control system or a decentral server, in order, thus, to form a corresponding measuring system. The fill level value L can be transferred via the interface. It is, however, also possible to transfer just the distance value d, or just the measurement curve. This provides the advantage that the installed height h of the fill level measuring device 1 for computing the fill level value L can be stored not in the fill level measuring device 1 but, instead, de-centrally and can be changed.

In the state of the art, it is possible by means of the corresponding method, such as the ultrasonic, FMCW, TDR, or pulse travel time method, to resolve the fill level L pointwise with an accuracy in the sub-micrometer range, assuming ideal conditions (e.g., well-reflecting fill substance 2, flat fill substance surface, nothing, such as stirring mechanisms or other installed objects, in the signal path of the probe or of the radar or ultrasonic signal T_{HF}). Even in the case of rough or wavy fill substance surfaces or in dust containing atmospheres, a reliable measurement of fill level L on a certain point of the fill substance surface is possible by means of these methods. In the case of a flat fill substance surface with known container inner geometry, or in case of a correspondingly present linearization model, the fill volume, which the fill substance 2 instantaneously occupies in the container 3, can additionally be directly determined from the fill level value L. In such case, the linearization model can, in turn, be stored in the fill level measuring device 1, or in the evaluation unit 4, in order to determine the fill volume based on the linearization model. The container inner geometry can be ascertained, for example, in turn, from the construction documentation, or CAD files, for the container 3.

When the type of fill substance 2 is known, such that a uniform fill substance density can be assumed, it is, moreover, possible, based on the ascertained fill volume, to calculate the mass of the fill substance 2 located in the container 3, again, with the calculating occurring either in the fill level measuring device 1 or in the evaluation unit 4.

The determination of fill volume by pointwise fill level measurement in combination with a linearization model reaches its limits, when the surface of the fill substance 2, such as shown in FIG. 1, is not flat. Such can occur in the case of high viscosity or bulk good-like fill substances 2, for example, when, during filling of the container 3, a bulk goods cone forms, or after the raising of the earlier tilted container 3, such as shown in FIG. 1. In addition, the removal of fill substance 2 can lead to extraction funnels on the fill substance surface. When the fill level measuring device 1 determines the fill level L only pointwise at one location of the surface of the fill substance 2, this can under these circumstances lead to faulty interpretations of fill level L and fill volume. Thus, for example, an emptying process is stopped when an empty container 3 is ascertained by the fill level measuring device 1, even though fill substance 2 is still present along the sides of the container interior. In the opposite case, it cannot be excluded in the case of full container 3 that a filling procedure is not paused, although a maximum fill level is already exceeded at a position of the fill substance surface, since this is not detected by means of the fill level measuring device 1.

In order to be able correctly to determine fill volume and mass of the fill substance 2 in the container also under these conditions, on the one hand, use is made of the recognition of the invention that, in the case of high viscosity and granular fill substances 2, depending on their properties, such as density, moisture content, porosity, grain size, roughness and viscosity, one and the same, characteristic bulk-good angle α forms. In such case, the bulk-good angle α forms differently depending on type of state changes i, ii, iii. In this connection, the terminology, “state change”, refers to the erecting of the container 3 and its filling/emptying. In accordance therewith, at least three distinguishable state changes i, ii, iii result, as shown in FIG. 2:
(i) erecting of the container 3 after its filling.
(ii) filling of the container 3 after its erecting and/or emptying.
(iii) emptying of the container 3 after its erecting.

All illustrated state changes i, ii, iii are characterized by features including that the bulk-good angle α characterizing each fill substance-type is exemplified for each case in a different way. When the container 3 according to the first type i of state change is first filled and then erected, the fill substance surface falls with the bulk-good angle α from that side, from which the container 3 was earlier erected. For the case in which the container 3 corresponding to state change ii is filled only after its erecting, a bulk-good cone forms on the fill substance surface. In the case of emptying the container according to the state change type iii, an extraction funnel forms in the fill substance surface.

In all three state changes i, ii, iii shown in FIG. 2, it is assumed that the state is virtually static. This means, on the one hand, that the container 3 is not being tilted, nor erected, and, on the other hand, that a constant emptying/filling rate reigns, wherein this includes a not filling, or not emptying (rate=0).

Based on the different types of state change i, ii, iii, in the case of known bulk-good angle α, it is possible according to the invention to derive, at least approximately, mutually differing fill substance surface geometries in the container 3, in order to correct the fill volume based on a smooth, horizontally extending fill substance surface:
(i) In the case of state change i, the true fill volume is corrected with respect to a horizontally extending fill substance surface using a truncated cylinder (in case of a round container cross-section), or using a wedge-shaped volume part (in the case of square container cross-section), wherein the wedge or angle of truncation corresponds to the bulk-good angle α.
(ii) When a state change ii is present, the volume of the fill substance 2 in the container (again, with reference to a horizontally extending fill substance surface) is corrected using the volume of a cone, wherein the cone angle can be set equal to the bulk-good angle α.
(iii) The state change of type iii behaves analogously, in the case of which the angle of the extraction funnel corresponds at least approximately to the bulk-good angle α.

Based on this case-dependent influence of the bulk-good angle α on the actual fill volume, according to the invention, for each fill substance-type, three case-dependent linearization models can be created. In such case, the linearization model of the invention concerns, besides the container inner geometry, the bulk-good angle α and the resulting fill substance surface as a function of preceding, or expected, state change i, ii, iii. Conversely, for applying the correct linearization model, the fill level measuring device 1, or the evaluation unit 4, must know which type of state change i, ii, iii last occurred in the container 3. In order to ascertain this, for example, a position sensor can be provided in the fill level measuring device 1, or on the container 3, in order to register possible tilting or raising of the container 3. For ascertaining possible ingoing and/or outgoing flows of fill substance 2, for example, control signals for filling/emptying can be noted. Also, a possibly registered history of measured fill level values L can be used to detect the type of state change i, ii, iii. In principle, however, also separate flow measuring devices can be arranged on the supply and drain lines of the container 3 for this. Gathering these individual pieces of information can facilitate determination of the type of state change.

The bulk-good angle α depends on the properties of the fill substance-type, thus, essentially on its density, porosity, viscosity, grain size, and roughness. However, also environmental factors can have an influence, especially the humidity, which can affect the moisture content of the fill substance 2. Accordingly, the bulk-good angle α is individually determined for each fill substance-type, for which the linearization model of the invention is to be used. An option for such is, on the one hand, to determine experimentally the bulk-good angle α for the fill substance-type of interest and then manually predetermine the case-dependent linearization models, for example, by transmitting the corresponding angle value to the evaluation unit 4. An experimental determining is possible, for example, at the container 3 by means of the measuring system 1, 4 when the currently contained volume V₀ of fill substance 2 is known, and when state change of type i is present, thus, the container 3 was righted after filling.

In such case, use can be made of the fact that it can be determined, in the case of likewise known inner geometry of the container 3, how high the fill level L needs to be for the theoretical assumption of a horizontally extending fill substance surface. By means of measuring the actual fill level L by the fill level measuring device 1, it is possible, taking into consideration the measuring position and the direction from which the container 3 was raised, to derive the bulk-good angle α by comparison with the theoretical value. In contrast with the experimental determination, it is, however, also possible to calculate the bulk-good angle α on a model basis using the above mentioned fill substance properties.

Especially this variant for the inventive determining of fill volume offers the advantage that no calibration of the measuring system needs to be performed at the container 3 to generate the linearization model of the invention. In such case, the linearization model can be generated, for example, based on “ray tracing”, the “discrete element method (DEM)” or the “Lagrange particle model (LPM)”. In general, the linearization model of the invention offers the advantage that the fill volume, and/or the corresponding fill substance mass, can be ascertained with little measuring effort with comparably good accuracy, for example, without three-dimensional surface detection.

The embodiment of the invention described with respect to FIG. 2 for creating case-dependent linearization models rests on the fact that each fill substance-type has its own bulk-good angle α. In contrast with such form of embodiment, it is possible within the scope of the invention to define according to the invention, instead of the bulk-good angle α, also corresponding, geometric bulk-good variables. Thus, there can be defined as bulk-good variable, for example, also a fill substance type-dependent, contour map of the fill substance surface, which is described, for example, in the form of a mathematical function. Advantageously, this permits, in given cases, a yet more exact approximation of the fill volume with only slightly increased calculative effort.

### LIST OF REFERENCE CHARACTERS

1 fill level measuring device
2 fill substance
3 container
4 evaluation unit
L fill level
R_{HF} reflected radar signal
T_{HF} transmitted radar signal
i, ii, iii type of state change
α bulk-good angle

1-12. (canceled)

13. A method for creating a linearization model, which describes a relationship between a fill level value measured by a travel time method and a fill volume of a fill substance in a container, the method comprising:
determining an inner geometry of the container;
determining at least one geometric bulk-good variable; and
creating the linearization model as a function of:
the inner geometry of the container;
the geometric bulk-good variable; and a preceding, or expected, type of state change of the container.

14. The method according to claim 13, wherein the type of state change is defined such that the type of state change is distinguished at least between the:
erecting of the container after its filling;
filling of the container after its erecting and/or emptying;
emptying of the container after its erecting; and
emptying of the container after its filling.

15. The method according to claim 13, wherein the bulk-good variable is determined by a model-based calculation as a function of a property of the fill substance, including at least one of: a density, a moisture, a porosity, a grain size, a roughness, and a viscosity.

16. The method according to claim 13, wherein, when the type of state change is the erecting of the container after its filling, the bulk-good variable is determined based on:
the measured fill level value; and
a known fill-volume of the fill substance.

17. The method according to claim 13, wherein the bulk-good variable is manually predeterminable.

18. The method according to claim 13, wherein the linearization model is generated as a numerical table or as a mathematical function.

19. The method according to claim 13, wherein the bulk-good variable is a characteristic bulk-good angle.

20. A measuring system for determining a fill volume of a fill substance in a container, the measuring system comprising:
a fill level measuring device arranged on the container to be operable for pointwise measuring of the fill level of the fill substance; and
an evaluation unit configured to:
determine a preceding, or expected, type of state change; and
calculate the fill volume based on measured fill level from the measuring device and on the linearization model of claim 13 and corresponding to the determined type of state change.

21. The measuring system according to claim 20, wherein a density of the fill substance is furnished in the evaluation unit, and wherein the evaluation unit is configured to determine a mass of the fill substance in the container based on the determined fill volume and the density.

22. The measuring system according to claim 20, further comprising a position sensor adapted to facilitate determining the type of state change.

23. The measuring system according to claim 22, wherein the position sensor is an integral component of the fill level measuring device.

24. The measuring system according to claim 20, wherein the evaluation unit is part of a superordinated server or a portable calculating device.

25. The measuring system according to claim 20, wherein the evaluation unit is configured to generate the linearization model.

26. A method for determining a fill volume of a fill substance in a container using the measurement system according to claim 20, the method comprising:
pointwise measuring of a fill level of the fill substance in the container; and
calculating the fill volume, or mass of the fill substance, based on the measured fill level value and the linearization model.
